(19) United States
(12) Patent Application Publication
(10) Pub. No.: US 2012/0331039 A1
(43) Pub. Date: Dec. 27, 2012

(54) Remote Server Management Using a Mobile Computing Device

(75) Inventors: Jeremy Armand Tillman, Bellevue, WA (US); Fabian Uhse, Bellevue, WA (US); Robert Richard Hanz, Redmond, WA (US); David J. Anderson, Kirkland, WA (US)

(73) Assignee: Microsoft Corporation, Redmond, WA (US)

(21) Appl. No.: 13/167,901

(22) Filed: Jun. 24, 2011

(51) Int. Cl. G06F 15/16

(52) U.S. Cl. 709/203; 709/223

(57) ABSTRACT

The subject disclosure is directed towards remotely monitoring and/or managing a server computing environment using a mobile computer, such as a smart phone. The server transmits information about the server computing environment and the mobile computer receives the transmission and displays the information. A user of the mobile computer may request additional information from the server, which may be sent to and displayed on the mobile computer. A user may also perform various actions in the server computing environment as directed via the mobile computer.

### BACKGROUND

Server management refers to the maintenance and operation of a server computer. The maintenance and operation may include such tasks as backing up or rebooting the server or monitoring the health of the server and/or the client computers connected to it. Historically, these tasks have been performed at the server computer. More recently, remote server management has allowed these and other tasks to be performed from a computer other than the server computer.

Remote server management may be performed by a user on a different computer on the same network as the server, or using a web browser, on any internet connected computer. However, in order to perform the server management, the user needs to be at a computer, and actively monitoring the server. When a user is not at a computer and monitoring the server, the user may not be made aware that the server requires attention in a timely fashion.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which access to remote server management functionality may be provided via a mobile computing device, e.g., a smartphone. Such a mobile computing device may receive regular data feeds or updates, and provide an interface for presenting various types of information to the user of the mobile computing device. The user may subscribe to such a data feed for a remote server management service for one or more servers that the user desires to monitor.

The remote server management service may be implemented as a cloud service which receives real-time updates from a multitude of servers. The user may be authenticated by the mobile computing device that may pass the authentication on to the remote server management service, which may verify the user's privileges. The service may send information to the mobile computing device relating to the servers for which the user has subscribed and has permission to receive. The mobile computing device may output (e.g., display or speak) all or a portion of the information. Which information is displayed and how the information is displayed may depend upon the number and nature of the servers the user is monitoring.

In one aspect, a mobile computing device that is communicatively connected to a communications network receives server management information relating to a server computing device. At least a subset of the server management information may be converted into output (e.g., displayable) data based upon a data model accessible by (e.g., stored in) the mobile computing device, which outputs at least part of the output data. The data may be converted, for example, by processing received eXtensible Markup Language (XML) information.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing exemplary non-limiting networked components including exemplary components of a server computer.

FIG. 2 is a representation of an example flow of operations related to remote server management using a mobile computer.

FIG. 3 is a block diagram representing exemplary non-limiting networked components including exemplary components of a mobile computer.

FIG. 4 is a flow diagram representing example steps for facilitating remote server management via a mobile computer.

FIG. 5 is a flow diagram representing example steps for performing an aspect of remote server management from a mobile computer.

FIG. 6 is a flow diagram representing example steps for performing another aspect of remote server management from a mobile computer.

FIG. 7 is a flow diagram representing alternative example steps for performing remote server management from a mobile computer.

FIG. 8 is a block diagram representing exemplary non-limiting networked environments in which various embodiments described herein can be implemented.

FIG. 9 is a block diagram representing an exemplary non-limiting computing system or operating environment in which one or more aspects of various embodiments described herein can be implemented.

### DETAILED DESCRIPTION

Various aspects of the technology described herein are generally directed towards remotely managing a server or server computing environment from a mobile computing device. In one aspect, certain information is communicated by the server over a computer network. The information may be retransmitted to or received by the mobile computing device, which displays some or all of the information to a user. As will be understood, the user may perform additional server management functions using the mobile computing device.

It should be understood that any of the examples herein are non-limiting. For one, while a smartphone is one example of a mobile computing device, other types of computing devices may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and networking in general.

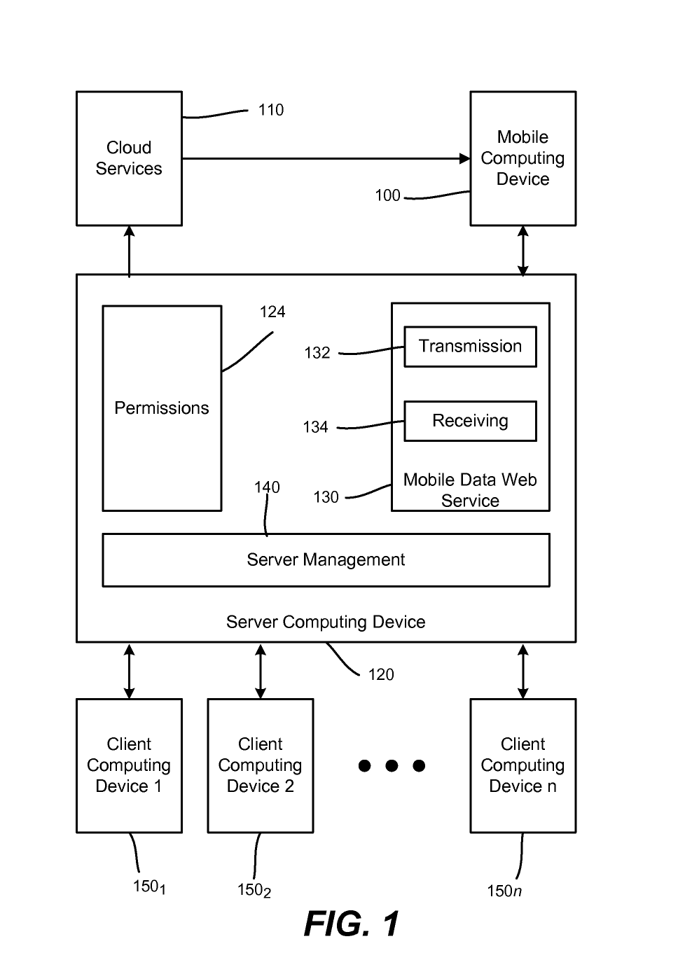

FIG. 1 shows a block diagram of an exemplary networked or distributed computing environment. The distributed computing environment comprises a mobile computing device 100 communicatively connected to cloud services 110 or the like and a server computing device 120. The server computing device 120, which may comprise one or more physical machines, is also communicatively connected to one or more client computing devices 150₁-150ₙ.

The server computing device 120 includes a transmission component 132 (e.g., an object) that transmits server management information over a computer network. The server management information may be transmitted or otherwise provided to the cloud services 110, which may communicate the information to the mobile computing device 100.

The server computing device 120 may include a permissions component 124 (e.g., object) for authenticating users and mobile devices and determining what server management information they may receive and what server management operations they are able to perform. The permissions component 124 may be incorporated into the server computing device 120 (as shown in the example) or an external component (e.g., of a service) coupled to the server computing device 120.

The server computing device 120 includes (or is coupled to) a server management component 140 that monitors various aspects of the server and any client computers 150₁-150ₙ that are connected to the server. The server management component 140 may also perform various server management functions.

The server computing device 120 shown in FIG. 1 also includes a mobile web data service component 130 that interfaces with the mobile computing device 100. The mobile web data service component 130 includes a communication component (transmission component 132 and/or receiving component 134), the transmission component 132 configured to communicate information (including downloading data) from the server computing device 120 to the mobile computing device 100. For example, the server may send server management information that may include an indication of the health of the server computing device and/or the health of a client device or devices coupled to the server; the information may include or comprise an alert, such as when the server computing device or at least one client device meets a predetermined condition. The mobile web data service component 130 includes a receiving component 134 for receiving requests or uploading data from the mobile computing device 100 to the server computing device 120.

As described herein, for various reasons the mobile computing device 100 is configured to request data from, provide data to, and/or send commands to the server computing device 120. In general, a user may monitor a server computing environment including a server computing device 120 and the clients 150₁-150ₙ using the mobile computing device 100. The monitoring may be facilitated by the cloud service 110. The user may receive an alert or notification about the server computing device 120 or a client (e.g., 150₂) that requires action via the cloud service 110.

When this occurs, the user may, using an interface of the mobile computing device 100, command the server computing device 120 to perform a corrective action, based on the technology described herein. The server computing device 120 may receive the command through the receiving component 134 at the mobile data web service 130, and verify that the user is permitted to issue such command using the permission component 124. The server management component 140 may perform the corrective action. The server computing device 120 may verify the command to the mobile computing device 100 via the mobile web data service 130 using the transmission component 132. The server 120 may also transmit updated information using the transmission component 132.

The mobile computing device 100 may request additional server management information for outputting via the mobile computing device 100. The mobile computing device 100 may receive input (e.g., via user interaction) that is directed towards the server computing device 120 or a client computing device (e.g., 150₁) coupled to the server computing device 120. For example, the input may correspond to a command to reboot the server computing device 120 or a client computing device 150₁, with a corresponding reboot command communicated to the server computing device 120. The input may correspond to a command to perform a backup of the server computing device 120 or one or more of the client computing devices 150₁-150ₙ. The input may correspond to a request to download data from the server computing device 120 to the mobile computing device 100, or upload data from the mobile computing device 100 to the server computing device 120. The data may correspond to image data, audio data, video data, and/or text data.

Another request for additional information may correspond to a request to view a listing of the users with access to the server computing device 120, along with the associated access rights of those users. A request to perform an action may be to modify the access rights of one or more of the users, add one or more users, or delete one or more users.

Another request for additional information may correspond to a request to view files and/or folders on the server computing device 120.

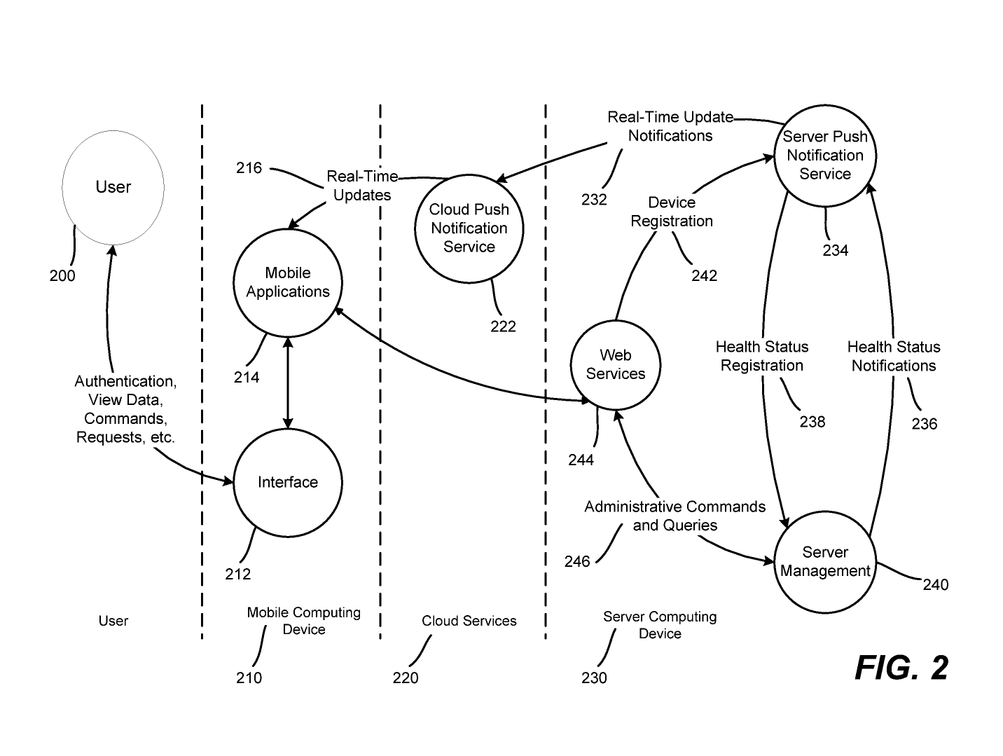

FIG. 2 shows an exemplary flow of operations representing interactions between entities as shown in FIG. 1. As can be seen by following the diagram flow, a user 200 interacts with a mobile computing device 210 through an interface 212. These interactions may include authentication of the user, viewing data, requests to upload or download data or view additional data, or to issue commands to the server computing device 230. The interface interacts with mobile applications 214, which may receive real-time updates 216 from a cloud push notification service 222. This service 222 may be one of many cloud services 220. The cloud push service 222 receives real-time update notifications 232 from a server push notification service 234. Alternatively, the mobile applications 214 may receive the real-time update notifications 232 from the server push notification service 234 directly, or through a different intermediary service, and/or may pull notifications on demand.

The server push notification service 234 may register to receive health status notifications 236 from server management 240 via health status registration 238. The server push notification service 234 receives device registration 242 from web services 244 informing it of which server management data to push to which mobile computers 210. Web services 244 may receive requests from mobile applications 214 to perform device registration 242 to associate a certain mobile computing device 210 with a certain server computing device 230.

The web services 244 may also receive other user requests for specific actions and pass them as administrative commands and queries 246 to server management 240. Server management 240 may act on these administrative commands and queries 246 and return information to the web service 244 to provide to the mobile applications 214.

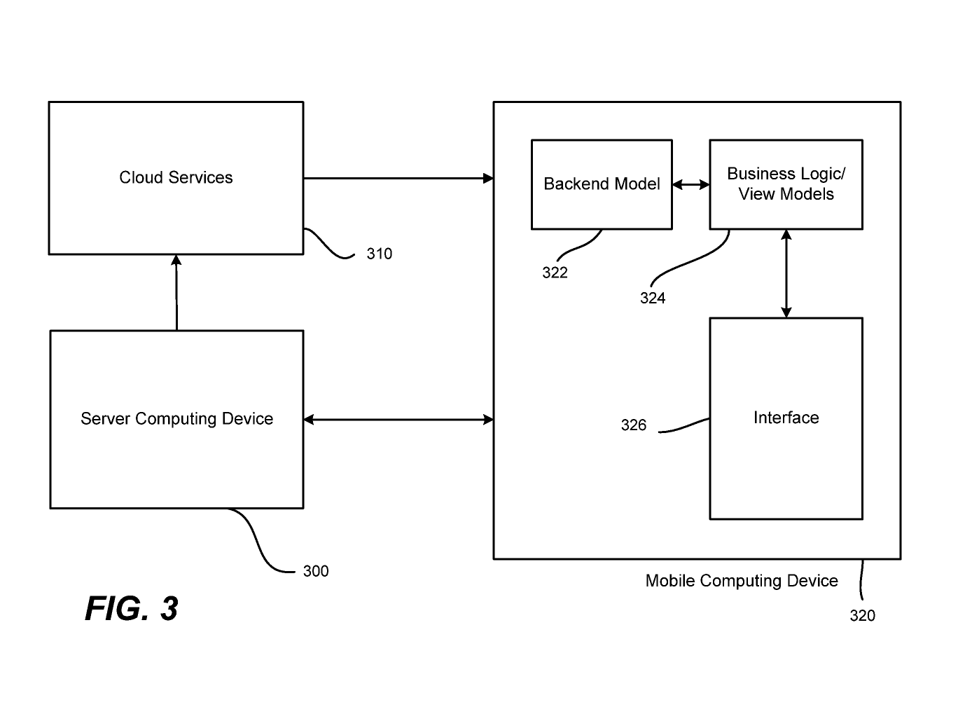

FIG. 3 shows example components of a mobile computing device 320, (e.g., corresponding to the mobile computing device 100 in FIG. 1). The mobile computing device 320 receives server management information from the cloud services 310, which received the server management information from the server computing device 300 (e.g., corresponding to the server computing device 120 in FIG. 1). Some or all of the server management information may be processed (e.g., interpreted/converted) by a backend model 322 or the like using business logic/view models 324 and displayed on the interface 326. A user may provide input to the interface 326. The input may be converted using the business logic/view models 324. The mobile computing device 320, using the backend model 322, may send the converted input to the server computing device 300.

After receiving a request from the mobile computing device 320, the server computing device 300 may verify the permissions of the mobile computing device to make the request. The server computing device 300 may satisfy the request. The server computing device 300 may send information back to the mobile computing device 320. The server computing device 300 may also transmit updated information to the cloud services 310.

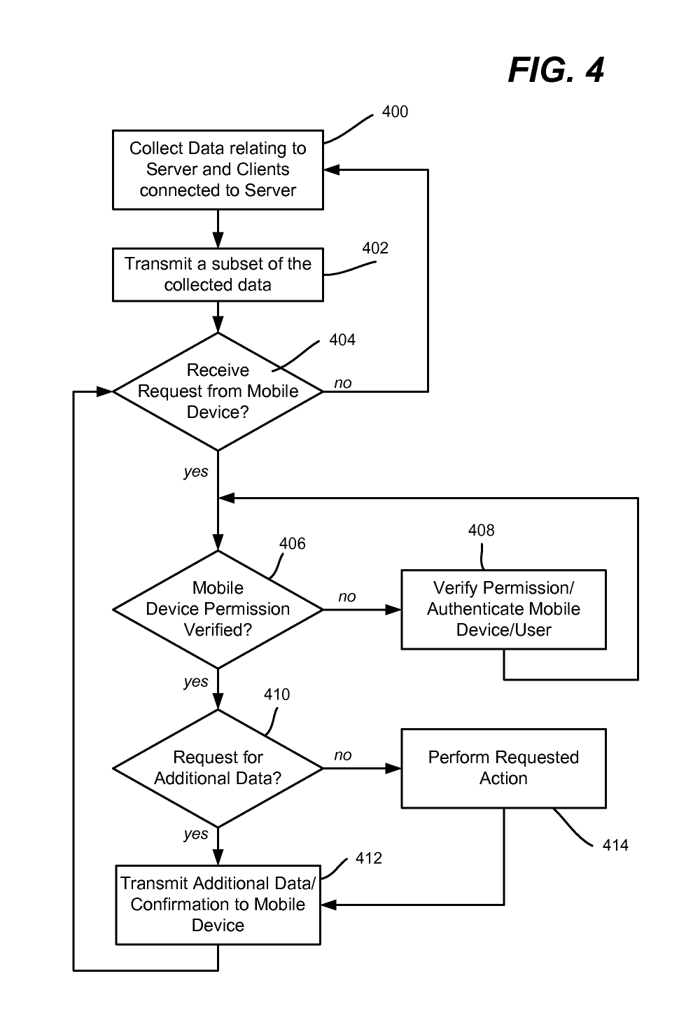

FIG. 4 shows example logic that may be used by the server computing device. In one implementation, the server collects data relating to the server and clients that are connected to the server at step 400. The server transmits some or all of the collected data over a computer network at step 402. Steps 400 and 402 are repeated while no requests are received from a mobile computing device at step 404, such as periodically and/or upon an appropriate status change having occurred in the server or server's clients. When a request is received from a mobile computing device at step 404, the server may verify that the mobile device (e.g., including user credentials as well) has permission to make the request at step 406.

When the mobile device does not have the requisite permission, the server may attempt to authenticate the mobile device and/or user at step 408. Assuming permission is verified at step 406, the server may determine whether the request at step 404 is for additional data at step 410. If the request received at step 404 is for additional data, (and such a request is allowed based upon the permission), the server transmits the additional data at step 412. If the request at step 404 is determined at step 410 not to be for additional data, the server performs the action at step 414 that was requested at step 404, (assuming that action requested is permitted for this user/mobile device).

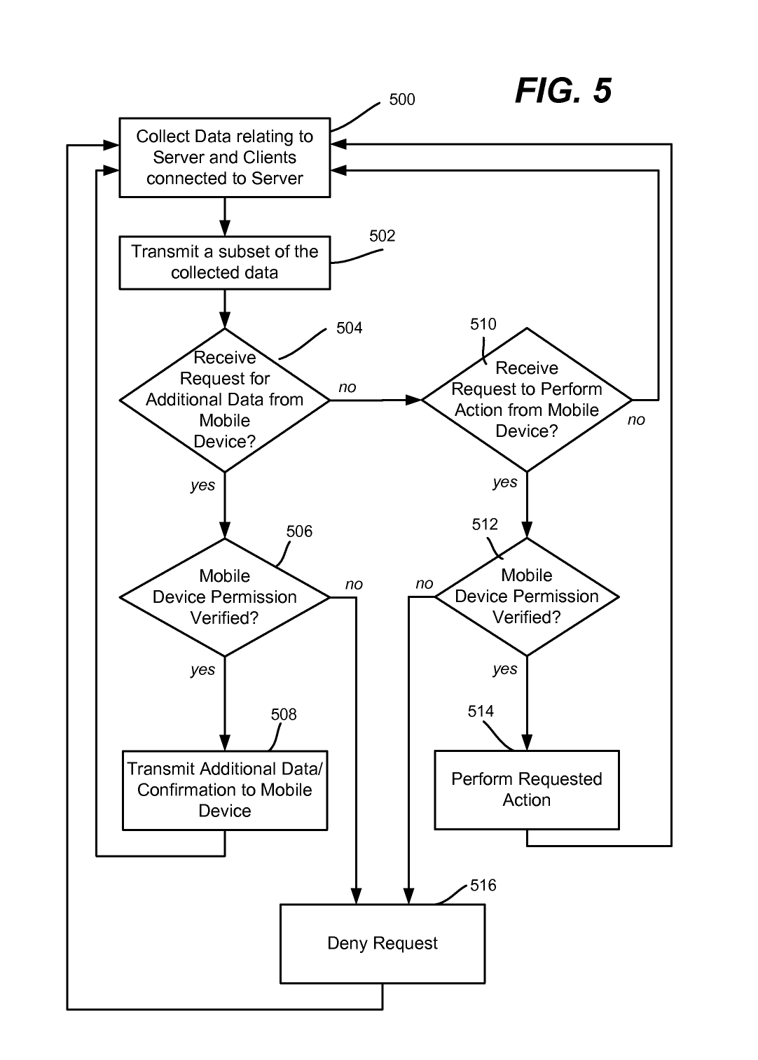

FIG. 5 shows an alternative exemplary logic of another aspect that a server may use to facilitate remote server management using a mobile computing device. The server collects data relating to the server and clients that are connected to the server at step 500. The server transmits some or all of the collected data over a computer network at step 502. While no request for additional data is received at step 504, and no request to perform an action is received at step 510, the server repeats steps 500 and 502 (such as periodically).

If a request for additional data is received at step 504, the server determines whether the requestor has adequate permissions to receive the requested information at step 506. If the requestor has adequate permission, the server transmits the additional data to the mobile device at step 510. If the requestor does not have adequate permission, the request is denied at step 516.

If no request for additional data is received at step 504, and a request to perform an action is received at step 510, the server determines whether the requestor has adequate permission to request the action be performed at step 512. If the requestor has adequate permission, the server performs the requested action at step 514. If the requestor does not have adequate permission, the request is denied at step 516.

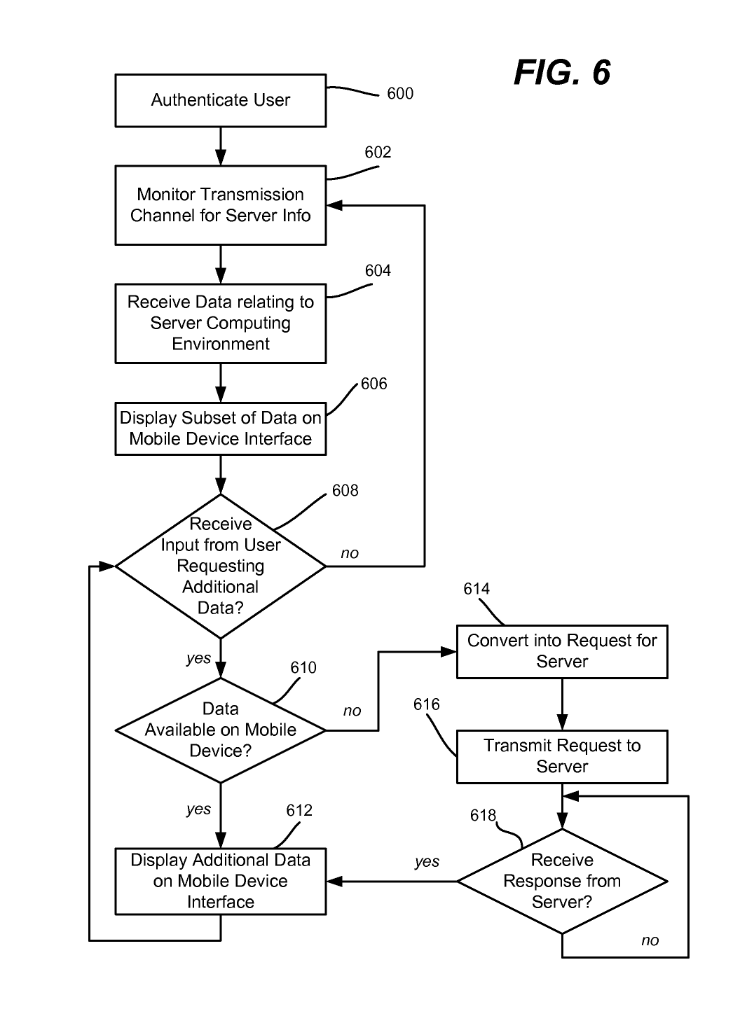

FIG. 6 shows an example logic that may be used by the mobile computing device. In one implementation, the mobile computing device authenticates the user at step 600. The mobile computing device monitors a transmission channel at step 602, and receives server management information transmitted to it at step 604. The mobile computing device may display some or all of the received data on a device interface at step 606. If no input is received from the user of the mobile computing device at step 608, the system repeats steps 602, 604, and 606.

If additional data is requested from the user at step 608, the device determines if the data is present on the mobile device at step 610. If the requested data is present on the device, the additional data is displayed on the interface at step 612, and the system again determines if there is a request for additional data at step 608. If the requested data is not present at step 610, the request is converted into a format that the server can receive, such as an eXtended Markup Language (XML) request at step 614. The mobile device transmits the converted request to the server at step 616, and waits to receive a response from the server at step 618. When a response is received at step 618, the mobile device displays the additional information on the interface at step 612, and the system again determines if there is a request for additional data at step 608.

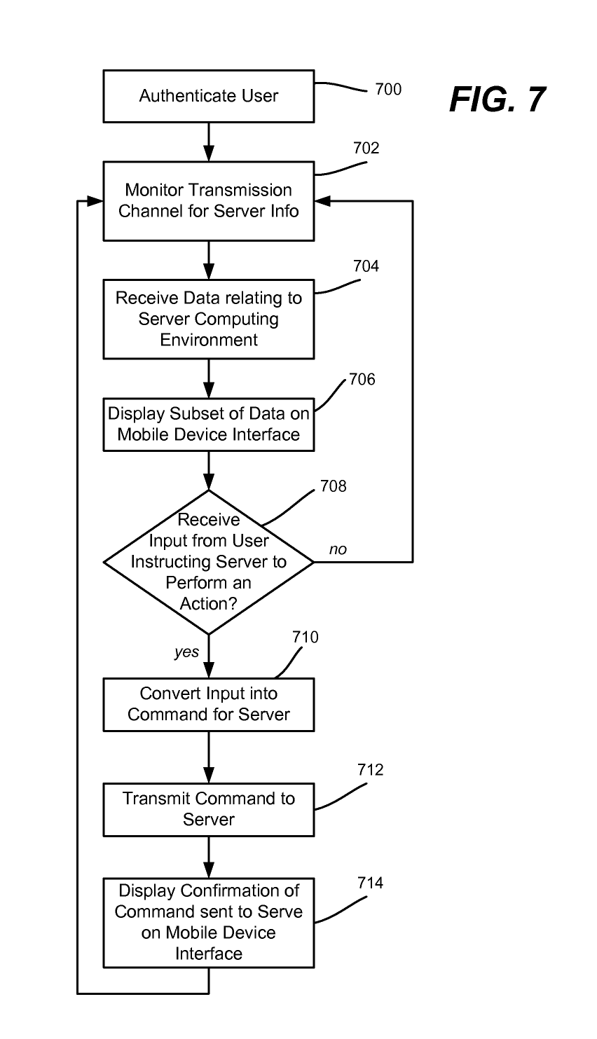

FIG. 7 shows an alternative example logic that may be used by the mobile computing device. The mobile computing device authenticates the user at step 700. The mobile computing device monitors a transmission channel at step 702, and receives server management information transmitted to it at step 704. The mobile computing device may display some or all of the received data on a device interface at step 706. If no input is received from the user of the mobile computing device at step 708, the system repeats steps 702, 704, and 706.

If user input is received instructing the server to perform an action at step 708, the mobile computing device converts the user input into an appropriately formatted (e.g., XML) command at step 710. The mobile computing device sends the command to the server computing device at step 712. The mobile computing device displays a confirmation that the command was sent using the interface. The mobile computing device returns to monitoring the transmission channel at step 702.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

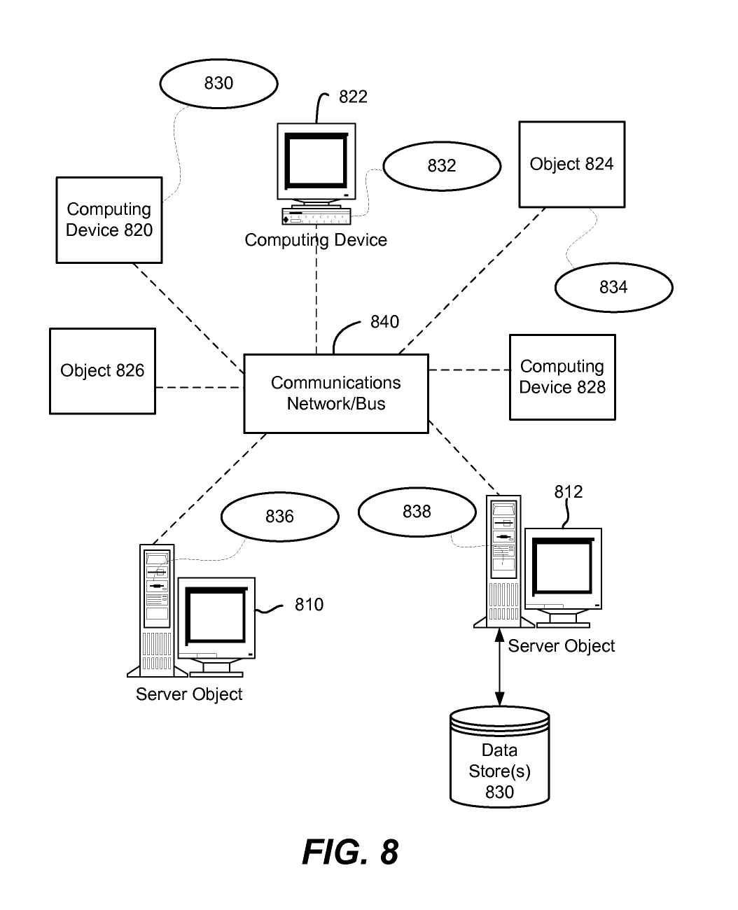

FIG. 8 provides a schematic diagram of an exemplary networked or distributed computing environment. The distributed computing environment comprises computing objects 810, 812, etc., and computing objects or devices 820, 822, 824, 826, 828, etc., which may include programs, methods, data stores, programmable logic, etc. as represented by example applications 830, 832, 834, 836, 838. It can be appreciated that computing objects 810, 812, etc. and computing objects or devices 820, 822, 824, 826, 828, etc. may comprise different devices, such as personal digital assistants (PDAs), audio/video devices, mobile phones, MP3 players, personal computers, laptops, etc.

Each computing object 810, 812, etc. and computing objects or devices 820, 822, 824, 826, 828, etc. can communicate with one or more other computing objects 810, 812, etc. and computing objects or devices 820, 822, 824, 826, 828, etc. by way of the communications network 840, either directly or indirectly. Even though illustrated as a single element in FIG. 8, communications network 840 may comprise other computing objects and computing devices that provide services to the system of FIG. 8, and/or may represent multiple interconnected networks, which are not shown. Each computing object 810, 812, etc. or computing object or device 820, 822, 824, 826, 828, etc. can also contain an application, such as applications 830, 832, 834, 836, 838, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 8, as a non-limiting example, computing objects or devices 820, 822, 824, 826, 828, etc. can be thought of as clients and computing objects 810, 812, etc. can be thought of as servers where computing objects 810, 812, etc., acting as servers provide data services, such as receiving data from client computing objects or devices 820, 822, 824, 826, 828, etc., storing of data, processing of data, transmitting data to client computing objects or devices 820, 822, 824, 826, 828, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 840 or bus is the Internet, for example, the computing objects 810, 812, etc. can be Web servers with which other computing objects or devices 820, 822, 824, 826, 828, etc. communicate via any of a number of known protocols, such as the hypertext transfer protocol (HTTP). Computing objects 810, 812, etc. acting as servers may also serve as clients, e.g., computing objects or devices 820, 822, 824, 826, 828, etc., as may be characteristic of a distributed computing environment.

### Exemplary Computing Device

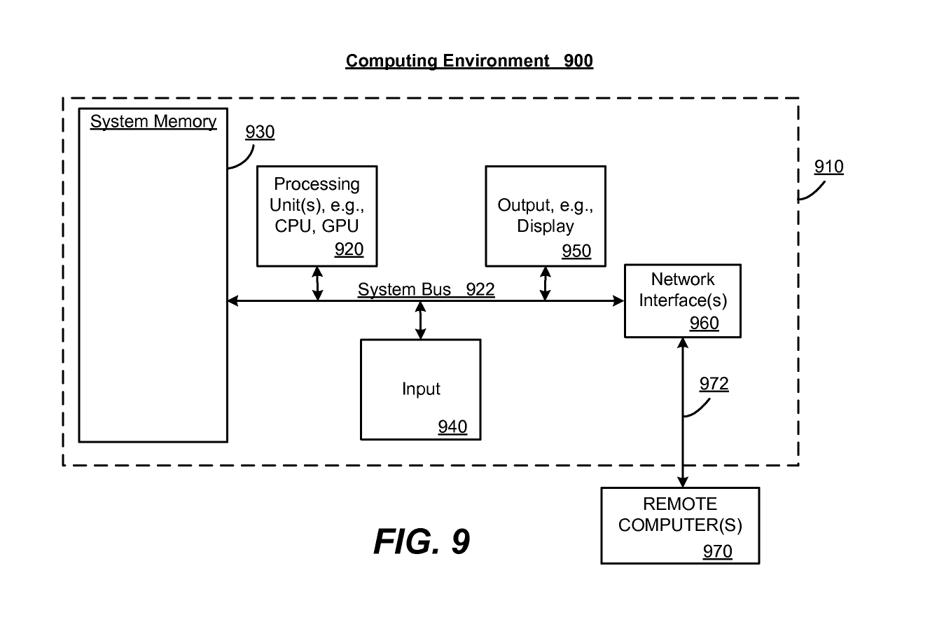

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 9 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 9 thus illustrates an example of a suitable computing system environment 900 in which one or aspects of the embodiments described herein can be implemented, although as made clear above, the computing system environment 900 is only one example of a suitable computing environment and is not intended to suggest any limitation as to scope of use or functionality. In addition, the computing system environment 900 is not intended to be interpreted as having any dependency relating to any one or combination of components illustrated in the exemplary computing system environment 900.

With reference to FIG. 9, an exemplary remote device for implementing one or more embodiments includes a general purpose computing device in the form of a computer 910. Components of computer 910 may include, but are not limited to, a processing unit 920, a system memory 930, and a system bus 922 that couples various system components including the system memory to the processing unit 920.

Computer 910 typically includes a variety of computer readable media and can be any available media that can be accessed by computer 910. The system memory 930 may include computer storage media in the form of volatile and/or nonvolatile memory such as read only memory (ROM) and/or random access memory (RAM). By way of example, and not limitation, system memory 930 may also include an operating system, application programs, other program modules, and program data.

A user can enter commands and information into the computer 910 through input devices 940. A monitor or other type of display device is also connected to the system bus 922 via an interface, such as output interface 950. In addition to a monitor, computers can also include other peripheral output devices such as speakers and a printer, which may be connected through output interface 950.

The computer 910 may operate in a networked or distributed environment using logical connections to one or more other remote computers, such as remote computer 970. The remote computer 970 may be a personal computer, a server, a router, a network PC, a peer device or other common network node, or any other remote media consumption or transmission device, and may include any or all of the elements described above relative to the computer 910. The logical connections depicted in FIG. 9 include a network 972, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
receiving, at a mobile computing device that is communicatively connected to a communications network, server management information relating to a server computing device;
converting at least a subset of the server management information into output data; and
outputting at least part of the output data via the mobile computing device.

2. The method of claim 1 further comprising, requesting additional server management information, receiving the additional server management information, and outputting at least part of the additional server management information.

3. The method of claim 1 further comprising, receiving input at the mobile device, the input directed towards the server computing device or a client computing device coupled to the server computing device, and communicating a communication to the server computing device based on the input.

4. The method of claim 3, wherein receiving the input includes receiving a command to reboot the server computing device or a client computing device coupled to the server computing device, and wherein communicating the communication includes communicating a corresponding reboot command to the server computing device.

5. The method of claim 3, wherein receiving the input includes receiving a command to perform a backup of the server computing device or one or more of the client computing devices, and wherein communicating the communication includes communicating a corresponding backup command to the server computing device.

6. The method of claim 3, wherein receiving the input includes receiving a request to download data from the server computing device to the mobile computing device, and wherein communicating the communication includes communicating a corresponding download request from the mobile communication device to the server computing device to download the data.

7. The method of claim 3, wherein receiving the input includes receiving a request to upload data from the mobile computing device to the first server computing device, and wherein communicating the communication includes uploading data corresponding to the request from the mobile communication device to the first server computing device.

8. The method of claim 7, further comprising receiving the requested data from the first server computing device in response to communicating the download request, the requested data corresponding to at least one of image data, audio data, video data, or text data.

9. The method of claim 1 wherein the server management information includes an indication of the health of the server computing device, or the health of at least one client device coupled to the server computing device, or both an indication of the health of the server computing device and the health of at least one client device coupled to the server computing device.

10. The method of claim 9 wherein the indication of the health of the server computing device includes an alert when the server computing device or at least one client device coupled to the server computing device meets a predetermined condition.

11. In a computing environment, a system comprising, a server computing device that is communicatively connected to a computer network, the server computing device configured to facilitate remote management of the server computing device via a mobile computing device, the server computing device including a server management component configured to manage data regarding the server computing device and a plurality of client computing devices connected to the server computing device, the server management component further configured to perform an action on the server computing device or at least one of the client computing devices in response to receiving a request to perform the action, the server computing device further comprising a communication component configured to communicate, via the computer network, information regarding the server computing device or one or more of the plurality of client computing devices to the mobile computing device, the communication component further configured to receive a request from the mobile computing device directed towards management of the server computing device or one or more of the plurality of client computing devices, the server computing device directing the server management component to perform an action corresponding to the request.

12. The system of claim 11 wherein the server computing device includes or is coupled to a permission component, the permission component configured to verify permission data associated with the request.

13. The system of claim 11, wherein the communication component is further configured to include at least one set of health information or at least one alert regarding the server computing device or one or more of the plurality of client computing devices in the information.

14. The system of claim 11 wherein the request to perform the action comprises a request to reboot the server computing device, backup the server computing device, communicate data from the server computing device to the mobile computing device, or receive data from the mobile computing device, or any combination of reboot the server computing device, backup the server computing device, communicate data from the server computing device to the mobile computing device, or receive data from the mobile computing device

15. The system of claim 11, wherein the request to perform the action comprises a request to reboot one or more of the plurality of client computing devices or backup one or more of the plurality of client computing devices.

16. The system of claim 11, wherein the communication component is further configured to receive a request for additional information, the request for additional information comprising a request to view a listing of a plurality of users and associated access rights of the users, and wherein the communication component is further configured to send the listing of the plurality of users and associated access rights of the users to the mobile computing device.

17. The system of claim 16, wherein the communication component is further configured to receive the request to perform the action, wherein the request to perform the action comprises at least one of modifying the access rights of one or more of the plurality of users, adding one or more users to the plurality of users, or deleting one or more of the plurality of users, and wherein the server management component is further configured to modify the access rights of one or more of the plurality of users, add one or more users to the plurality of users, or delete one or more of the plurality of users as requested.

18. The system of claim 11, wherein the communication component is further configured to receive the request for additional information, wherein the request comprises a request to view at least one of a plurality of files or a plurality of folders on the server computing device, and wherein the communication component is further configured to send the at least one of the plurality of files and the plurality of folders to the mobile computing device.

19. In a computing environment, a method performed at least in part on at least one processor, comprising:
collecting information relating to a server computing device and a plurality of client computing devices connected to the server computing device;
communicating at least a subset of the information from the server computing device over a computer network that the server computing device is communicably connected to;
receiving, from a mobile computing device, one or more requests to send additional information relating to at least one of the server computing device or one or more of the plurality of client computing devices to the mobile computing device, the additional information comprising at least one of:
a health status of the server computing device or one or more of the plurality of client computing devices;
a listing of the server computing device and other computing devices that are connected to the server computing device;
information relating to usage of storage on the server computing device;
a listing of a plurality of users associated with the server computing device; or
a listing of media available from the server computing device to the mobile computing device;
verifying the permission level associated with the request; and
communicating, in response to receiving the request and verifying the permission level associated with the request, the additional information from the server computing device to the mobile computing device.

20. The method of claim 19, further comprising:
receiving, from the mobile computing device a request to perform an action comprising at least one of:
rebooting, powering on, or powering off, the server computing device or one or more of the plurality of client computing devices;
performing a backup of the server computing device or of one or more of the client computing devices;
downloading data from the server computing device to the mobile computing device;
uploading data from the mobile computing device to the server computing device;
modifying the permissions level of one or more of the plurality of users;
adding a new user to the plurality of users; or
deleting one or more of the plurality of users; and
performing, in response to receiving the request and verifying the permissions level associated with the request, the respective action.
